(19) United States
(12) Patent Application Publication
(10) Pub. No.: US 2023/0233016 A1
(43) Pub. Date: Jul. 27, 2023

(54) NOZZLE AND BEVERAGE PREPARATION MACHINE

(71) Applicant: Koninklijke Douwe Egberts B.V., Utrecht (NL)

(72) Inventors: Hendrik Johan Dees, Utrecht (NL); Thomas De Jong, Nieuw-Vennep (NL); Dennis Kemp, Nieuw-Vennep (NL)

(21) Appl. No.: 18/011,815

(22) PCT Filed: Jun. 23, 2021
(86) PCT No.: PCT/EP2021/067267

§ 371 Date: Dec. 20, 2022

(30) Foreign Application Priority Data
Jun. 24, 2020 (GB) 2009643.4

(51) Int. Cl. A47J 31/44; A47J 31/46; B01F 23/235; B67D 1/14

(52) U.S. Cl. CPC A47J 31/4485; A47J 31/46; B01F 23/235; B67D 1/1416; B01F 2101/07

(57) ABSTRACT

A nozzle 20 has a fluid flow passage 26 which defines a fluid flow path from an inlet 5 end of said passage towards an outlet end of said passage. A restrictor 29a is movable under the control of an actuation system 27 relative to the passage to vary the minimum cross-sectional area of the fluid flow path through the passage. The restrictor 29 is moved to project into the passage to provide a restricted opening in the passage or removed from the passage to allow an unrestricted flow through the 10 passage. The nozzle 20 is particularly suitable for use in a beverage preparation machine to generate microfoam in a beverage. When the restrictor 29 is retracted from the passage 29, the passage and the restrictor can be cleaned by flushing the nozzle. The restrictor 29 may be a pin-like member aligned with the passage and moveable parallel to the axis of the passage.

### TECHNICAL FIELD OF THE INVENTION

The present invention relates to a nozzle suitable for use as a foam generating nozzle in a beverage preparation machine and to a beverage preparation machine comprising such a nozzle.

### BACKGROUND TO THE INVENTION

Beverages comprising a microfoam are increasingly popular, especially milky coffee drinks. Crema on coffee is also a form of microfoam. It is known to use a nozzle with a small cross-sectional flow area in a beverage preparation machine, such as a coffee machine, to generate microfoam in a beverage. For example, a nozzle having a circular flow path through which the beverage flows with a diameter of less than 1 mm has been found to be very effective for foaming coffee and milk. A problem with the known nozzle arrangements is that they tend to become blocked over time and are difficult to clean or flush out. Often this requires the intervention of a service engineer to resolve.

There is a need, therefore, for an alternative nozzle which can be used in a beverage machine to generate a foam in a beverage which overcomes, or at least mitigates, some or all of the disadvantages of the known nozzles.

There is a need in particular for an alternative foam generating nozzle which is easier to clean or flush out than the known foam generating nozzles.

The is also a need for a beverage preparation machine comprising an alternative nozzle which can be used to generate foam in a beverage which overcomes, or at least mitigates, some or all of the disadvantages of the known machines.

There is a need in particular for an alternative beverage preparation machine having a foam generating nozzle which is easier to clean or flush out than the known foam generating nozzles.

### SUMMARY OF THE INVENTION

Aspects of the invention relate to a nozzle, especially a nozzle for generating foam in a beverage, and to a beverage preparation machine.

According to a first aspect of the invention, there is provided a nozzle having a fluid flow passage which defines a fluid flow path from an inlet end of said passage towards an outlet end of said passage, the nozzle having a restrictor movable relative to the passage to vary the minimum cross-sectional area of the fluid flow path through the passage, the nozzle having an actuator arrangement for moving the restrictor.

In a nozzle according to the first aspect of the invention, the restrictor can be moved to reduce the minimum cross-sectional area of the flow path to provide a restricted opening for use, say, in generating a foam in a beverage and moved to increase the minimum cross-sectional area of the flow path to allow the nozzle to be cleaned by flushing or when there is no requirement to generate a foam.

In an embodiment, the restrictor is movable to at least one retracted position in which it is fully withdrawn out of the passage.

In an embodiment, the restrictor is movable to at least one advanced position in which the restrictor projects into the passage. The restrictor may be movable to any one of a range of different advanced positions in which the restrictor projects into the passage by differing amounts. At least part of the fluid flow path through the passage may be defined by a gap between the restrictor and a surface of the passage when the restrictor projects into the passage.

In an embodiment, the passage has a longitudinal axis and the restrictor is elongate, having a longitudinal axis parallel to or co-axial with the axis of the passage, the cross-sectional area of the restrictor being smaller than that of the passage. The restrictor and the passage may be the same shape in lateral cross-section.

In an embodiment, the restrictor is an elongate pin-like member aligned parallel to or co-axially with an axis of the passage and is reciprocally movable in a direction parallel to said axis.

The actuator arrangement may comprise a stepper motor.

In an embodiment, the nozzle comprises a body defining a bore having an axis and wherein the passage is located in a region of the bore co-axial with said axis, the nozzle comprising an inlet port for directing fluid into the bore upstream of the passage, the restrictor being aligned parallel to or co-axially with the bore and the passage, the actuator arrangement being adapted to move the restrictor reciprocally along the bore to move the restrictor into and out of the passage. The passage may be defined by an annular sleeve mounted in the bore or it may be defined by a part of the bore itself. The inlet port may be configured to direct fluid into the bore in a direction substantially orthogonal to the axis of the bore. The body may be a single integral component or constructed from a number of separate components assembled together. In an embodiment, the body may define the bores of two or more nozzles according to the first aspect of the invention. The restrictor may be an elongate pin-like member, the nozzle being configured such at that the pin-like member is locatable in at least one advanced position in which part of the pin-like member penetrates the passage whilst another part of the pin-like member is located in the bore opposite the inlet port such that fluid entering bore through the port is directed onto the pin-like member and is able to enter the passage by flowing about the pin-like member. The pin-like member may be locatable in at least one retracted position in which it is fully withdrawn from the passage so as to be wholly located on the opposite side of the inlet port from the sleeve. The actuator arrangement may comprise an actuator member reciprocally slidable in a further region of the bore which extends beyond the inlet port on the opposite side of the inlet port from the sleeve. The actuator member may have a main body portion slidably located in the main bore, the pin-like restrictor member projecting from an end of the main body facing the passage. A seal arrangement may be provided to prevent fluid flowing past the main body portion of the actuator member in the bore.

In an embodiment, the passage is cylindrical and at least part of the restrictor which projects into the passage is cylindrical but with a smaller outer dimeter than the passage.

In an embodiment, the nozzle is a part of a foam generating apparatus in a beverage preparation machine.

In accordance with a second aspect of the invention, there is provided nozzle having a fluid flow passage which defines a fluid flow path from an inlet end of said passage towards an outlet end of said passage and a restrictor movable under the control of an actuation system relative to the passage to vary the minimum cross-sectional area of the fluid flow path through the passage. The restrictor may be moved to project into the passage to provide a restricted opening in the passage and moved to remove it from the passage to allow an unrestricted flow through the passage. The restrictor may be a pin-like member aligned with the passage and moveable parallel to the axis of the passage.

In accordance with a third aspect of the invention, there is provided a beverage preparation machine having apparatus for generating foam in a beverage ingredient, the foam generating apparatus including at least one nozzle according to either of the first and second aspects of the invention as defined above.

The foam generating apparatus may have more than one nozzle according either of the first and second aspects of the invention as defined above. In an embodiment, the foam generating apparatus comprises at least two of said nozzles fluidly connected or connectable in series or in parallel. In an embodiment, the foam generating apparatus comprises four of said nozzles, a first pair of said nozzles being fluidly connectable in series and a second pair of said nozzles being fluidly connectable in series. The foam generating apparatus may comprise at least one actuator operatively connected with the restrictor of at least two of said nozzles for simultaneously moving the restrictors of said at least two nozzles relative to their respective passages. The actuator may be operatively connected with the restrictors of all the nozzles in the foam generating apparatus. In an embodiment, each of the at least two nozzles comprises a bore having an axis wherein the passage is located in a region of the bore and an inlet port for directing fluid into the bore upstream of the passage, wherein the restrictor is elongate and extends parallel to or co-axially with the passage, the actuator arrangement being adapted to move the restrictor reciprocally along the bore to move the restrictor into and out of the passage. The bores of the at least two nozzles may be defined in a common body.

### DETAILED DESCRIPTION OF THE INVENTION

In order that the invention may be more clearly understood one or more embodiments thereof will now be described, by way of example only, with reference to the accompanying drawings, of which:

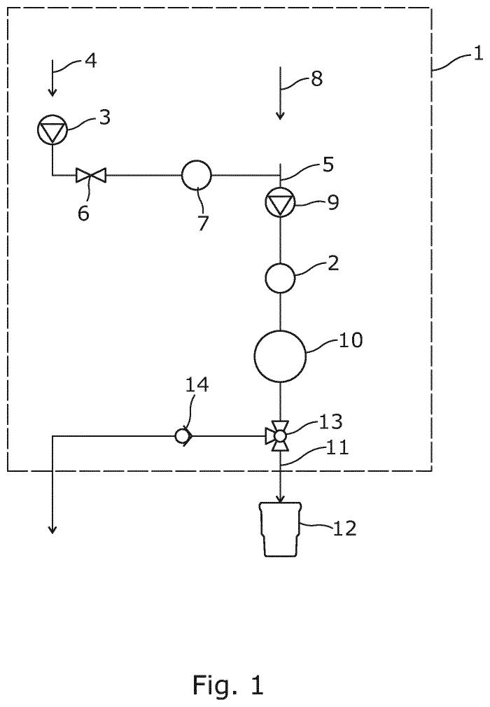

FIG. 1 is a schematic diagram illustrating part of a fluid flow system in an embodiment of a beverage preparation machine incorporating at least one nozzle according to an aspect of the invention;

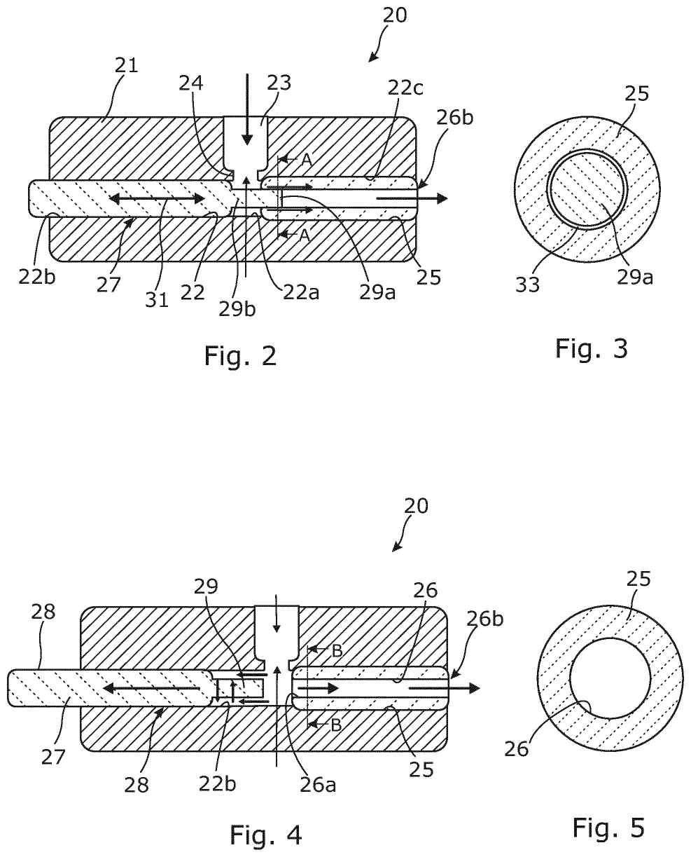

FIG. 2 is a longitudinal, somewhat schematic, cross-sectional view through an embodiment of a nozzle according to an aspect of the invention showing the nozzle in a foam generating configuration;

FIG. 3 is a transverse cross-sectional view through part of the nozzle of FIG. 2 taken on line A-A;

FIG. 4 is a view similar to that of FIG. 2 but showing the nozzle in a non-foam generating configuration;

FIG. 5 is a cross-sectional view through part of the nozzle of FIG. 4 taken on line B-B;

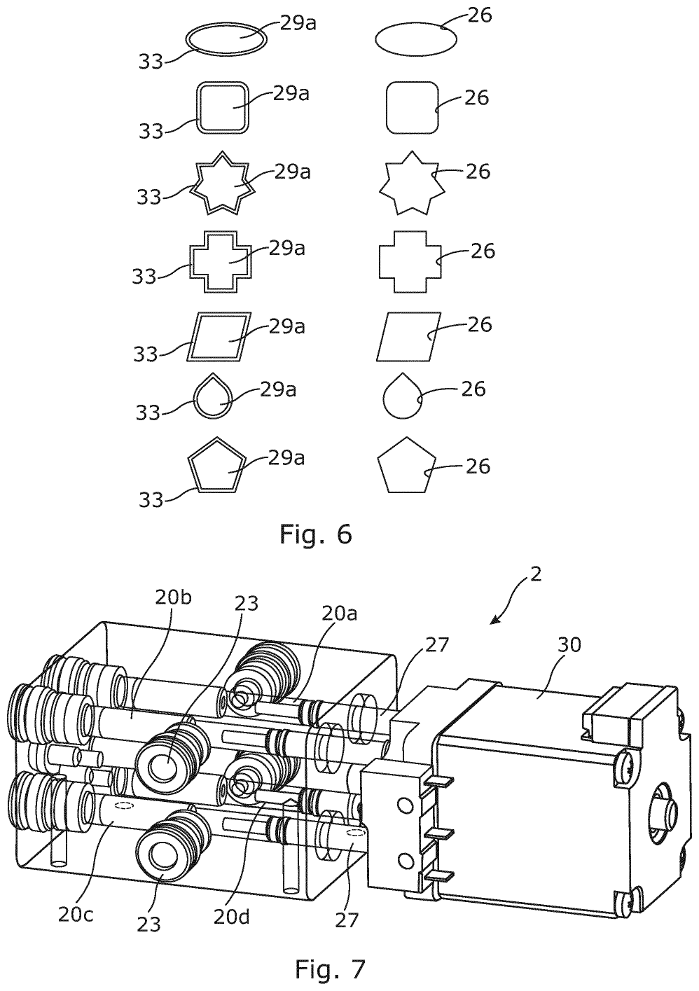

FIG. 6 illustrates how a range of different cross sectional shapes can be adopted for a fluid flow passage and restrictor forming part of the nozzle of FIGS. 2 to 4, with the images on the left being cross-sectional views taken on line A-A in FIG. 3 and the corresponding images on the right being cross-sectional-views as taken on line B-B of FIG. 5;

FIG. 7 is a perspective view of a multi-channel foam generating apparatus for use in beverage preparation machine which incorporates four foam generating nozzles according to an aspect of the invention, with a body forming part of the apparatus ghosted so as to show internal details;

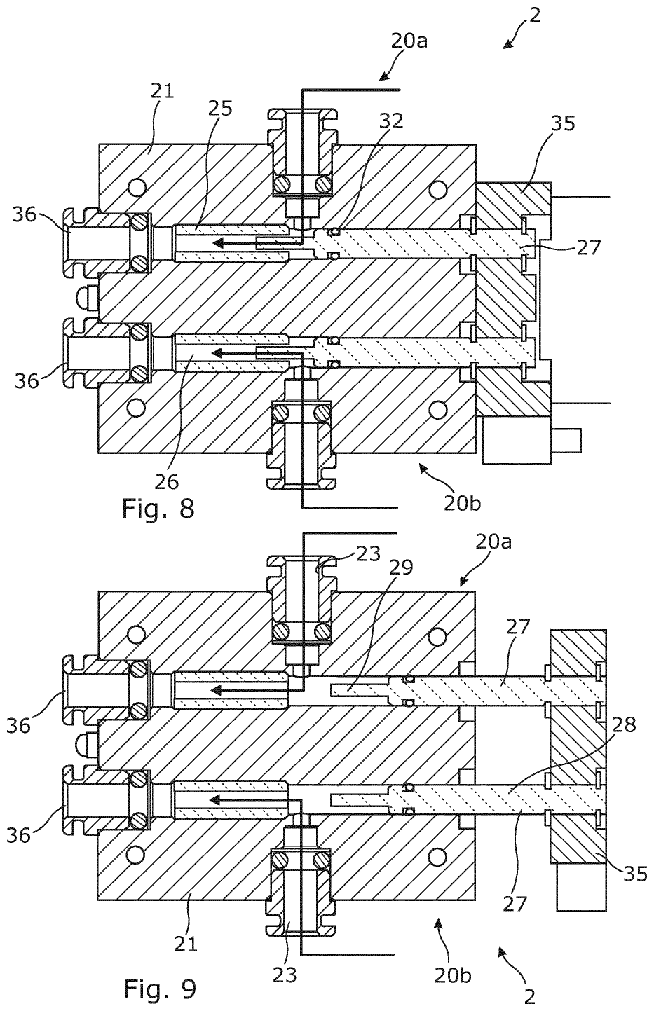

FIG. 8 is a longitudinal cross-sectional view taken through part of the apparatus of FIG. 7, showing the apparatus in a foam generating configuration; and,

FIG. 9 is a view similar to that of FIG. 8 but showing the apparatus in a non-foam generating configuration.

Embodiments of the invention will now be described with reference to a nozzle for generating foam or froth in a beverage and which forms part of a beverage preparation machine. Nozzles in accordance with the invention can be used in machines for the preparation of wide variety of beverages both hot and cold, including, but not limited to: coffee (including expresso and milky coffee); milk (which may be flavoured), chocolate, and tea.

FIG. 1 is a schematic representation of part of a fluid flow path in an embodiment of a beverage preparation machine 1 having a foam generating apparatus 2 which incorporates at least one nozzle in accordance with the invention. In the machine, a gas pump 3 selectively delivers a gas 4 under pressure into a fluid line 5 via a valve 6 and restriction 7. The gas 4 is mixed with a liquid beverage ingredient 8 from a source (not shown) and a pump 9 is operative to pump the gas/liquid mixture through the foam generating apparatus 2, which can be selectively used to generate a foam in the gas/liquid mixture. From the foam generating apparatus 2, the mixture (which may or may not be foamed) is directed through an in-line heater 10 before being dispensed via a dispensing outlet 11 into a suitable container, such as a cup 12. A dump valve 13 is located in the fluid line between the heater 10 and a dispensing outlet 11. The dump valve 12 is selectively operable to divert the fluid to a dump via a one-way valve 14.

In a coffee type beverage preparation machine, the gas 4 will usually be air and be mixed with a liquid ingredient of the beverage, such as water, coffee, milk, a coffee/milk mixture, chocolate milk or the like. However, nozzles according to the invention can be configured for use with a wide variety of gas/liquid combinations and could be adapted for use in applications other than for foaming a beverage ingredient.

A first embodiment of a nozzle 20 in accordance with an aspect of the invention is illustrated schematically in FIGS. 2 to 5. One or more nozzles 20 of this type can be incorporated into a foam generating apparatus 2 in a beverage preparation machine 1, such as that illustrated in FIG. 1.

The nozzle 20 comprises a body 21 which defines an elongate cylindrical main bore 22 extending through the body. Partway along the length of the main bore, the body defines an inlet port 23 having an inlet channel 24 which opens into the bore 22. The inlet port 23 is in the form of a cylindrical stepped bore whose axis is aligned substantially at 90 degrees to the axis of the main bore. The inlet port 23 is fluidly connected with a source of a mixture of gas and liquid which is to be frothed, such as fluid line 5 and pump 9 in the machine of FIG. 1.

The main bore 22 has a generally central region 22a where the inlet port 23 enters, a second region 22b to the left of the inlet port as shown and which can be referred to as an actuator region and a third region 22c to the right of the inlet port as shown and which can be referred to as a flow region.

Located in the third region 22c of the main bore is a cylindrical, annular pipe or sleeve 25. The sleeve 25 is a tight fit in the main bore 22c so that fluid is unable to flow between the exterior of the sleeve and the surface of main bore. Alternatively, a seal arrangement can be used to prevent fluid from flowing between the exterior of the sleeve and the surface of main bore. A central passage 26 of the sleeve defines a flow path from an inlet end 26a of the passage proximal the inlet port 23 and an opposite outlet end 26b. The outlet end of the passage is fluidly connected with the dispensing outlet 11 of the beverage preparation machine from which the prepared beverage is dispensed into a suitable container, such as cup 12. In an alternative embodiment, the passage 26 is formed directly in the body 21.

A cylindrical actuator member 27 is slidable located in the second region 22b of the main bore. The actuator member 27 has a main body portion 28 which is a close sliding fit in the main bore 22b and a smaller diameter, elongate pin-like portion 29 at the end facing the sleeve. The pin-like portion 29 is cylindrical and is aligned coaxially with the passage 26 through the sleeve 25. The pin-like member has an outer diameter which is slightly smaller than the inner diameter of the sleeve 25 so that it can be inserted into the passage with a small clearance. The pin-like portion 29 will be referred to as a restrictor.

The actuator member 27 is operatively connected with an actuator (30, FIG. 7) which is configured to slide the actuator member 27 reciprocally within the main bore 22b, as indicated by arrow 31, between an advanced or foam generating position as shown in FIGS. 2 and 3 and a retracted or non-foam generating position as shown in FIGS. 4 and 5. The actuator 30 in this embodiment is a stepper motor but any suitable actuator capable of moving the actuator member 27 linearly along the bore in a reciprocal manner could be used. Other suitable types of actuator include a linear electronic or fluid power actuator, for example. A seal (32, FIG. 8) is located about the exterior of the main body portion 28 of the actuator member 27 proximal to its inner end. The seal 32 engages the surface of the main bore 22b to prevent fluid flowing past the seal 32 between the main body portion 28 of the actuator member 27 and the surface of the main bore 22b.

When the actuator member 27 is in an advanced or foam generating position as shown in FIGS. 2 and 3, a free end region 29a of the pin-like restrictor 29 projects into the passage 26 of the sleeve 20. The restrictor 29 has a slightly smaller outer diameter than the inner diameter of the sleeve 25 so that there is a small annular gap 33 between the restrictor 29 and the inner surface 34 of the sleeve 25 through which fluid can flow. Part of the restrictor 29b closer to the main body portion remains outside the sleeve but locates within the central region 22a of the main bore 22 opposite the inlet port 23. In use, the gas/liquid mixture flows under pressure through the inlet port 23, where it collides with the exposed part of the restrictor 29b before flowing through the narrow annulus 33 between the restrictor 29 and sleeve 25 and the along the remainder of the passage 26 towards the dispensing outlet. The impact of the gas/liquid mixture with the restrictor 29b on entry into the main bore 22 and its passage through the narrow annulus 33, which acts as a restricted nozzle, generates a foam in the gas/liquid mixture. By varying the amount by which the restrictor 29 penetrates the along passage 26, the degree of restriction can be adjusted to vary the foam generating characteristics. In general, the more the restrictor 29 projects into the passage 26 the greater the restriction in the flow path and the more foam that is generated. The less distance the restrictor 29 projects into the passage the less the restriction and the less foam is generated. Accordingly, the actuator 30 can be controlled to move the actuator member 27 into a variety of different advanced or foam generating positions according to a predetermined algorithm in order to generate a desired amount of foam for any given gas/liquid mixture.

When the actuator member 27 is in its retracted, non-foam generating position as shown in FIGS. 3 and 4, the restrictor 29 does not project into the passage 26 and indeed can be located in the second region 22b of the main bore 22a so that it is wholly located in the main bore on the opposite side of the inlet port 23 from the sleeve 22. In this position the restrictor does not impede flow through the inlet port 23 and the passage 26. The actuator member 27 may be moved to the retracted position in order to dispense a non-foamed beverage product through the nozzle. In this case, the liquid beverage product may not be mixed with a gas prior to passing through the nozzle. Furthermore, with the actuator member 27 and restrictor 29 in the retracted position, the restrictor 29 and the interior of the sleeve 25 can be flushed and cleaned. To this end, a liquid (which may be hot water and which could include chemicals for cleaning such as a descaling compound for example) is introduced into the main bore 22 through the inlet port 23. The liquid is able to flow about the restrictor 29, which is exposed in the main bore, and pass unobstructed through the passage 26. This may be carried out as part of a cleaning protocol according to a predefined algorithm under the control of an electronic control system of the beverage preparation machine or under the manual control of a user, say on selection of a cleaning function via a user interface.

In the nozzle 20 according to the invention, the cross-sectional area and length of the restricted opening through the nozzle can be varied. Accordingly, nozzles according to the invention may be termed variable opening or variable restriction nozzles.

In tests it has been found that satisfactory foam generation is achieved using a sleeve 25 with a passage 26 having a diameter of 2 mm and a restrictor 29 having an outer diameter in the range of 1.75 mm to 1.95 mm. This produces an annular gap 33 with an effective cross-sectional area in the range of about 0.74 mm² to 0.16 mm² when the restrictor 29 projects into the passage 26. This is equivalent to a fixed circular nozzle opening having a diameter in the range of about 0.97 mm to 0. 44 mm. It has been found that the restrictor 29 may only have to project into the passage by between 1 to 2 mm to generate a satisfactory microfoam. However, in a nozzle of the above dimensions the restrictor 29 may project into the passage 26 by anything between 0.5 mm to 6 mm or more when in a foam generating configuration. It will be appreciated that the above dimensions are exemplary only and can be varied. For example, the diameter of the passage 26 could be larger or smaller than 2 mm and the diameter of the restrictor 29 varied accordingly to provide a restricted passage 33 of the desired cross-sectional area. Those skilled in the art will have no difficulty in establishing suitable dimensions by means of trial and error for any given application. However, generally it is expected that the cross-sectional area of the restricted annulus 33 in the flow path through the passage will be less than about 0.79 mm² and more preferably will be in the range of 0.2 mm² to 0.6 mm² for generating microfoam in a beverage.

In the present embodiment, the passage 26 is cylindrical and the restrictor 29 is also cylindrical and co-axial with the passage. However, this is not essential and the passage 26 and restrictor 29 can take different forms provided the restrictor 29 can be introduced into the passage 26 to produce a restricted flow path for foam production. For example, as illustrated in FIG. 6, in lateral cross-section the passage 26 and the restrictor 29 may be elliptical, square or rectangular, star shaped with any given number of points, cross shaped with any suitable variation in width/depth, parallelogram, tear-drop shaped, pentagon or any type of polygon, for example. They could also be irregular in shape. Whilst the passage 26 and the restrictor 29 may have the same cross-sectional profile this is not necessarily essential. For example, the passage 26 could be circular in cross-section whilst the restrictor 29 has an alternative cross-sectional profile, such as a star or a polygon. Furthermore, it is not necessarily essential that the restrictor is co-axial with the passage 26 and the axis of the restrictor 29 could be off-set relative to the axis of the passage 26. It is also possible that the cross-sectional profile of the restrictor 19 varies along its length, at least in the region 29a that penetrates the passage 26.

FIGS. 7 to 9 illustrate an embodiment of a multi-channel foam generating apparatus 2 for use in a beverage preparation machine 1 such as that illustrated in FIG. 1. The apparatus 2 incorporates a number of variable restriction nozzles 20 similar to that described above. In the present embodiment, the apparatus incorporates four nozzles 20a to 20d but the number of nozzles can be varied depending on requirements. Each nozzle defines a flow path through which a beverage product ingredient can be routed. The or each beverage product ingredient will typically be a gas/liquid mixture where foam is to be generated but could be a liquid where no foam is to be produced. Not all the nozzles need be used at the same time. Two or more of the nozzles may be used for different beverage product ingredients which may be combined downstream. Two or more nozzles can also be used for the same beverage product ingredient. In this case, the nozzles may be connected in parallel. This is advantageous where a larger flow of the ingredient is to be dispensed than can be passed through a single nozzle. Where a beverage product ingredient is particularly difficult to foam, two or more nozzles may be connected in series so that the ingredient is passed through the nozzles sequentially.

Each of the nozzles 20a-20d in the apparatus 2 is essentially the same as that described above in relation to FIGS. 2 to 5, having a main bore 22, an inlet port 23, a sleeve 25 defining an inner passage 26 and an actuator member 27 having main body portion 28 carrying a restrictor 29. In the present embodiment, the main bores 22 are all defined in a single common body 21 extending parallel to one another through the body. The main bores 22 are arranged in an array comprising two rows and two columns, with each row and each column comprising two of the main bores. Whilst it may be convenient to provide the bores 22 for all the nozzles in a single body 21, this need not be the case. Each main bore 22 could be provided in a separate body 21 or there may be two or more bodies 21 with each body defining one, two or more main bores 22 depending on the number of nozzles required as well as packaging and manufacturing considerations.

In the present embodiment, the actuator members 27 of all four nozzles 20a-20d are operatively connected with a single actuator, in the form of a stepper motor 30 so that all the actuator members 27 are moved simultaneously and are either all advanced or all retracted. As shown, the actuator members are all connected with an actuator plate 35 which is moved by the stepper motor 30. However, in alternative embodiments more than one actuator could be provided with each actuator operatively connected with one or more of the actuator members. FIG. 8 shows a pair of the nozzles 22a, 22b with their actuator members 27 in an advanced, foam generating position whilst FIG. 9 shows the actuator members 27 in a retracted non-foam generating position. The flow of fluid through the nozzles is indicated by the arrows.

Each of the nozzles 20a-20d has an outlet port 36 at the downstream end of its main bore through which the beverage ingredient exiting the nozzle is directed. For use in the beverage preparation machine of FIG. 1, the outlet ports can be each fluidly connected with the in-line heater 10 and dispensing outlet 11. However, where it is necessary to pass the gas/liquid mixture through two or more nozzles to generate the required microfoam, the outlet port of one nozzle may be connected with the inlet port of another of the nozzles so that the nozzles are connected in series. This may be a permanent fluid connection or a valve arrangement may be provided to enable nozzles to be selectively connected in series when this required. In the embodiment of FIGS. 7 to 9 having four nozzles 22a-22d, the nozzles could be arranged in two pairs, with the nozzles in each pair connected in series. This would enable each pair of nozzles to be used to create a foam (especially a microfoam) in a different beverage ingredient. For example, one pair of nozzles 22a, 22b could be connected in series and used to generate foam in a mixture of air and coffee, whilst the other pair of nozzles 22c, 22d are connected in series to generate foam in a mixture of air and milk. The two pairs of nozzles may be operative at the same time and the beverage ingredients mixed after foaming or they could be used at different times to produce different beverages, either on their own or mixed with other beverage ingredients.

The embodiments are described above by way of example only. Many variations are possible without departing from the scope of protection afforded by the appended claims. It should be understood that variable opening/restriction nozzles in accordance with the invention can be utilised in many different types of beverage preparation machine and are not limited to use in a machine as illustrated in FIG. 1. For example, the beverage preparation machine need not use an in-line heater 10 downstream of the foam generating apparatus 2. Rather, at least the liquid component of the beverage ingredient may be heated prior to entering the foam generating apparatus 2 and could be heated by means of a boiler, for example. Indeed, whilst variable opening/restriction nozzles according to an aspect of the invention are particularly suitable for generating foam in a beverage preparation machine, nozzles according to the invention could be configured for use in other applications where it is desirable to provide a restriction in a flow path for a fluid which can be varied or removed, either to alter the effects of the restriction or to enable cleaning.

1. A nozzle having a fluid flow passage which defines a fluid flow path from an inlet end of said passage towards an outlet end of said passage, the nozzle having a restrictor movable relative to the passage to vary the minimum cross-sectional area of the fluid flow path through the passage, the nozzle having an actuator arrangement for moving the restrictor.

2. A nozzle as claimed in claim 1, wherein the restrictor is movable to at least one retracted position in which it is fully withdrawn out of the passage.

3. A nozzle as claimed in claim 1, wherein the restrictor is movable to at least one advanced position in which the restrictor projects into the passage.

4. A nozzle as claimed in claim 3, wherein the restrictor is movable to any one of a range of different advanced positions.

5. A nozzle as claimed in claim 1, wherein when the restrictor projects into the passage, at least part of the fluid flow path through the passage is defined by a gap between the restrictor and a surface of the passage.

6. A nozzle as claimed in claim 1, wherein the passage has a longitudinal axis and the restrictor is co-axial with or parallel to the passage, the cross-sectional area of the restrictor being smaller than that of the passage.

7. A nozzle as claimed in claim 6, wherein the restrictor and the passage are the same shape in lateral cross-section.

8. A nozzle as claimed in claim 1, wherein the restrictor is an elongate pin-like member aligned parallel or co-axially with an axis of the passage and is reciprocally movable in a direction parallel to said axis.

9. (canceled)

10. A nozzle as claimed in claim 1, the nozzle comprising a body defining a bore having an axis and wherein the passage is located in a region of the bore so as to extend parallel to or co-axial with said axis, the nozzle comprising an inlet port for directing fluid into the bore upstream of the passage, the restrictor being aligned parallel to or co-axially with the passage, the actuator arrangement being adapted to move the restrictor reciprocally along the bore to move the restrictor into and out of the passage.

11. A nozzle as claimed in claim 10, wherein passage is defined by an annular sleeve mounted in said region of the bore.

12. A nozzle as claimed in claim 10, wherein the restrictor is an elongate pin-like member, the nozzle being configured such at that the pin-like member is locatable in at least one advanced position in which part of the pin-like member penetrates the passage whilst another part of the pin-like member is located in the bore opposite the inlet port such that fluid entering bore through the port is directed onto the pin-like member and is able to enter the passage by flowing about the pin-like member.

13. A nozzle as claimed in claim 12, wherein the pin-like member is locatable in at least one retracted position in which the pin-like member is fully withdrawn from the passage so as to be wholly located on the opposite side of the inlet port from the sleeve.

14. A nozzle as claimed in claim 10, wherein the actuator arrangement comprises an actuator member reciprocally slidable in a further region of the bore which extends beyond the inlet port on the opposite side of the inlet port from the sleeve.

15. A nozzle as claimed in claim 1, wherein the passage is cylindrical and at least part of the restrictor which projects into the passage is cylindrical but with a smaller outer dimeter than the passage.

16. (canceled)

17. A beverage preparation machine having apparatus for generating foam in a beverage ingredient, the foam generating apparatus including at least one nozzle as claimed in claim 1.

18. A beverage preparation machine as claimed in claim 17, wherein the foam generating apparatus has more than one said nozzle.

19. A beverage preparation machine as claimed in claim 18, wherein the foam generating apparatus comprises at least two of said nozzles connected in series or in parallel.

20. A beverage preparation machine as claimed in claim 19, wherein the foam generating apparatus comprises four of said nozzles, a first pair of said nozzles being fluidly connectable in series and a second pair of said nozzles being fluidly connectable in series.

21. A beverage preparation machine as claimed in claim 18, wherein the foam generating apparatus comprises an actuator operatively connected with the restrictor of at least two of said nozzles for simultaneously moving the restrictors of said at least two nozzles relative to their respective passages.

22. A beverage preparation machine having apparatus for generating foam in a beverage ingredient, the foam generating apparatus including, at least two of said nozzles as defined in claim 10 and wherein the bores of said at least two nozzles are defined in a single, common body.
